(19) United States
(12) Patent Application Publication
(10) Pub. No.: US 2009/0205935 A1
(43) Pub. Date: Aug. 20, 2009

(54) REED AND PRESSURE SWITCHING SYSTEM FOR USE IN A LIGHTING SYSTEM

(75) Inventor: Markus Frick, Reno, NV (US)

Correspondence Address: SILVERSKY GROUP LLC, 5422 LONGLEY LANE , SUITE B, RENO, NV, 89511, UNITED STATES, 775-336-6464, TCASEY@SILVERSKYGROUP.COM

(73) Assignee: Night Operations Systems, Reno, NV (US)

(21) Appl. No.: 12/012,421

(22) Filed: Jan. 31, 2008

(51) Int. Cl. F21V 23/04

(52) U.S. Cl. 200/60

(57) ABSTRACT

A dual function switching system for use individually or in combination with a lighting system. Both a reed switch and a pressure switch connect to a lighting system's ballast circuitry and allows manual ON/OFF switching of the light without compromising the water-tight sealed ballast housing. The disclosed switching system also promotes a default-on design that allows a controlled light to continue to produce light even if the switching system is accidentally or intentionally removed or damaged.

### BRIEF DESCRIPTION OF THE INVENTION

The present invention is directed to lighting systems and illumination devices, and more particularly to one or more switching systems for a portable lighting system that can be used for non-covert and ultra-covert operations. The disclosed reed and pressure switching system connects directly to a light's ballast circuitry and allows dual function manual ON/OFF switching of the light without compromising a water-proof sealed ballast housing. The disclosed switching system also promotes a default-on circuitry design that allows the lighting system to continue to produce light even if the switching system is accidentally or intentionally removed or damaged.

### CROSS-REFERENCES TO RELATED APPLICATIONS

Not Applicable.

### STATEMENT AS TO THE RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

### BACKGROUND OF THE INVENTION

High intensity discharge (HID) lamps include mercury vapor, metal halide, high and low pressure sodium, xenon short-arc and other types of lamps. HID lamps produce light by generating an electric arc across two spaced-apart electrodes housed inside a sealed quartz or alumina arc tube filed with gas or a mixture of gas and metals. The arc tube is typically filled under pressure with pure xenon, a mixture of xenon-mercury, sodium-neon-argon, sodium-mercury-neon-argon, or some other mixture such as argon, mercury and one or more metal halide salts. A metal halide salt (or metal halide) is a compound of a metal and a halide, such as bromine, chlorine, or iodine. Some of the metals that have been used in metal halide lamps or bulbs include indium, scandium and sodium. Xenon, argon and neon gases are used because they are easily ionized, produce some level of immediate light, and facilitate the striking of the arc across the two electrodes when voltage is first applied to the lamp. The heat generated by the arc then vaporizes the sodium, mercury and/or metal halides, which produce light as the temperature and pressure inside the arc tube increases.

Since HID lamps are negative resistance devices, they require an electrical ballast to provide a positive resistance or reactance that regulates the arc current flow and delivers the proper voltage to the arc. Some HID lamps, called “probe start” lamps, include a third electrode within the arc tube that initiates the arc when the lamp is first lit. A “pulse start” lamp uses a starting circuit referred to as an igniter, in place of the third electrode, that generates a high-voltage pulse to the electrodes to start the arc. Initially, the amount of current required to heat and excite the gases is high. Once the chemistry is at its “steady-state” operating condition, much less power is required, making HID lamps more efficient (producing more light with less energy over a long period of time) than filament based lights.

The majority of light generated by a short gap HID lamp is produced by a small line source of plasma. This relatively small light source enables the output of the HID lamp to be more easily focused into an intense, narrow beam than many other light sources. A concave (parabolic or elliptical) shaped reflector, with a through-hole in the bottom through which the HID lamp is inserted, is used to focus the light. Most reflectors are formed from polished aluminum, which is sometimes coated with other reflective materials.

High intensity lighting systems are powerful tools that may be used in both covert and non-convert operations. A user's ability to switch or turn such a light on and off is of paramount importance. Traditional types of switching mechanisms in heavy duty and/or covert-oriented lights are pressure switches and some type of push/slide switch. A pressure switch is a simple mechanical design that operates by holding two electrically conductive metal contacts separated from one another until a user applies enough manual pressure on one of the contacts to force the two contacts together and complete an electrical circuit. Push/slide switches come in many different forms, such as toggle switches, push-button switches and rocker switches, to name a few. In each case, a user physically moves one portion of the switch to cause an electrical contact to move from one state to another (open to close or close to open).

Traditional pressure switching systems have several drawbacks, especially when used on handheld or mounted lighting systems. The mechanical components of the switch can break down after repeated use. When this occurs, the lighting system becomes practically useless, even though the rest of the lighting system is fully functional, i.e., what good is a light if you cannot turn it on? Another drawback relates to the fact that many pressure switching systems, as well as other types of switches, are designed to connect directly to the lighting system's battery pack, typically mounted at the back of the battery pack or on its side. Such switching systems are designed in this manner to keep the battery pack separated from the lighting system's ballast. Unfortunately, when the battery pack needs to be replaced, all of the switching system components must be removed, which complicates removal of the battery pack, increase the amount of time required to do so (which can be very dangerous in combat or covert operations), and risks damage and the potential loss of the switch or switch components.

Push/slide switches also have drawbacks in that they can be noisy, which is not desirable in covert use situations, the mechanical components and contacts can get fouled or shorted by water and debris (such as fine sand) that works its way into the switch, and the switch can form a point of entry for water and debris into other components of the lighting system. For example, if the switch is mounted on the battery pack, water and debris can work its way through the switch and into the battery back. Likewise, if the switch is mounted on the ballast assembly, water and debris can work its way into the ballast and the ballast electronics. To improve the water-resistant aspects of such switches, the push/slide-button, toggle or rocker may be covered with a rubber or similarly flexible material to seal the switch. Such seals are prone to wearing out over time and can be easily damaged, thereby destroying the water-resistant aspects of the switch.

Push/slide switching systems often require a user to apply a lubricant of some kind, such as an oil or gel, periodically throughout the lifetime of the system in order to ensure operability of the moving mechanical components. Not only is applying lubricants a hassle that can be skipped by many user, but when such lubricants are applied, they can additionally cause problems by turning any dirt, dust, or debris into a gummy residue that may clog up the switching system. Therefore, avoiding the need for lubricants is desirable.

Finally, both pressure switches and push switches suffer in underwater conditions due to increased atmospheric pressure. Pressure on the switch increases dramatically at greater depths and can trigger the switch, making such switching system highly undesirable below certain depths.

One solution to some of the problems with push switches is to use a magnetic reed switch instead of a push switch. Magnetic reed switches are also a type of push switch, but they can be designed to sit on the outside of a battery pack or ballast module, allowing a ballast circuit to be either closed or opened by a magnet while remaining completely sealed against water or debris contamination. Magnetic reed switching has previously been used in this way as switching for a handheld light (see my previous patent: Frick, U.S. Pat. No. 6,467,930), but it too can be problematic. Such a magnetic reed switch usually relies upon a mechanical component containing a magnet being moved by a user from one position to a second position. If debris lodges in the external mechanism of the switch, it can impede movement of the mechanical component, thereby preventing its use. Likewise, if the external mechanism of the reed switch is damaged in some way, such as by a bullet or shrapnel, the external magnet will be lost and the switch cannot by used.

Furthermore, lighting system switches are typically configured to open and close a circuit in the battery pack, which either cuts off or supplies power to the ballast or lamp. As a result, when the switch is damaged or lost in some way, no power can be supplied to the ballast or lamp. Also, since the switch is always configured in the off position, there is no other way to supply power to ballast or lamp.

### BRIEF DESCRIPTION OF THE SEVERAL VIEWS OF THE DRAWING

FIGS. 1A and 1B show two views of an assembled searchlight incorporating both a reed switching system and a pressure switching system;

FIGS. 2A and 2B show two views of an exploded reed switching system and a plug aperture for use in a pressure switching system; and

FIG. 3 shows the external components of a pressure switching system.

### DETAILED DESCRIPTION OF THE INVENTION

The present invention is directed to lighting systems and illumination devices, and more particularly to one or more switching systems for a portable lighting system that can be used for non-covert and ultra-covert operations. The disclosed reed and pressure switching system connects directly to a light's ballast circuitry and allows dual function manual ON/OFF switching of the light without compromising a water-tight sealed ballast housing. The disclosed switching system also promotes a default-on circuitry design that allows the lighting system to continue to produce light even if the switching system is accidentally or intentionally removed or damaged.

Portable lighting systems, such as flashlights, can be used in a wide variety of applications and are designed to be light, powerful, and durable. Such lights, especially high intensity lighting systems, can also be mounted to weapons, vehicles and various types of air and water craft. Thus, while the disclosed switching systems are primarily designed to be used with high-intensity lighting systems, the switching systems can be used with other types of light systems, from incandescent to light emitting diodes (LEDs). The disclosed system may also be used in all types of different settings, from non-covert uses to ultra-covert operations.

The reed switch (which may alternatively be referred to as a magnetic reed switching system) and the pressure switch (which may alternatively be referred to as a pressure tape switching system) herein disclosed are improvements over those switching systems previously used in handheld searchlight systems. An optimum embodiment of the disclosed invention uses both the disclosed reed switch and the disclosed pressure switch, because such a combination provides the best and most failsafe searchlight switching system. Of course, each of the disclosed switching systems may be used individually as well, and each individually is an improvement over prior uses of such switches. Features of the disclosed reed switch, including the default-closed circuit design, are improvements in and of themselves. Features of the disclosed pressure switch as well, including connecting directly to a ballast circuit, are improvements in and of themselves. To this end, the present disclosure is intended to cover each of the disclosed switches, a reed switching system and a pressure switching system, individually as well as in combination.

The magnetic reed switching system operates by a user moving a manual push or slide switch from an OFF position to an ON position, or vice versa, in order to turn the user's light either off or on, respectively. The reed switching system is designed so that a user may use a finger or thumb on one hand to easily manipulate the manual push/slide switch while holding the light with the same hand. Obviously, a user may use two hands to operate the switch as well. As is the case with reed switching systems in general, moving the manual push/slide switch moves an external magnet secured within or underneath the manual push/slide switch. When the external magnet is moved, its magnetic field either moves into or out of the presence of two contacts within the reed switch, one of which is magnetic and either attracted to or repelled by the external magnet.

Some reed switches include an internal magnet that is attracted to or repelled by the external magnet. Depending on how the magnets are arranged, when one magnet moves into the presence of the other magnet, the two magnets will either be attracted to one another or repelled by one another. The typical reed switch is designed so that one contact within the switch is attracted to the external magnet and is pulled toward the other contact to close a power circuit for the light. For example, a reed switch may contain two blades formed with a space between them within a hermetically sealed glass tube. When a magnet passes over the glass tube, the magnetic field pulls the two blades (one blade acting as a lead, and the other blade acting as a lead) causing them to contact, and in turn, close the circuit.

In the preferred embodiment of the present invention, the reed switch is built into the light's ballast housing, not the battery pack. The external portion of the reed switch is attached to the outside of the housing, and the internal portion is built within the water-proof housing containing the ballast circuitry. When the manual push/slide switch, and therefore the external magnet, is moved, the contacts of the reed switch either open or close the power circuit for the ballast. In its default position, the reed switch is set to close the power circuit. Hence the light is on unless the user turns it off. As a result, in the event the reed switch is damaged or removed in some way, the light will be left on, making the light useable even without the switch.

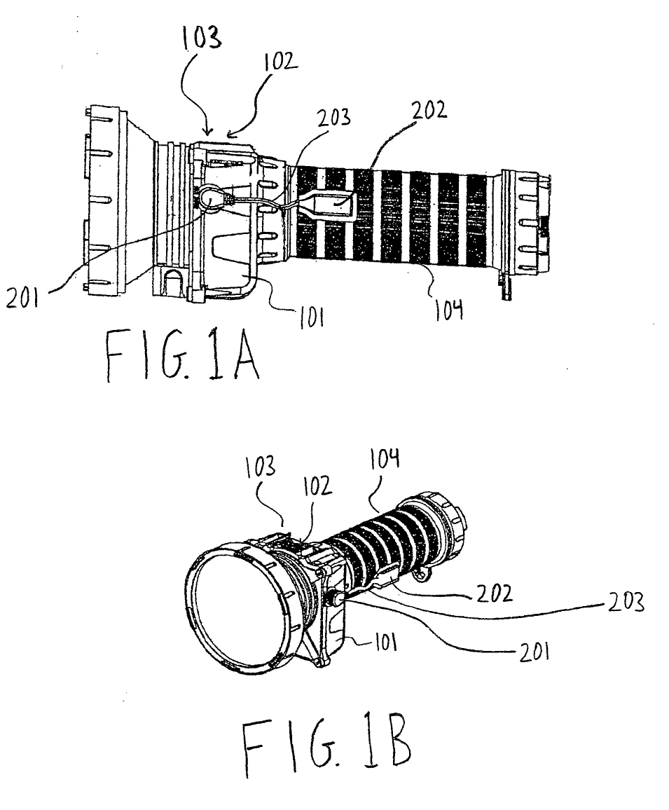

For example, if the manual push switch is knocked off during rough use, or even blown off by a bullet or shrapnel during a military operation, the light will continue to produce light because the reed switch is set by default to its ON position. To turn the light off, a user would simply need to remove, “back-off”, or disconnect the battery pack from the ballast housing. As illustrated in FIGS. 1A and 1B, the ballast housing 101, including slide switch 102 and switch cover 103, are connected to battery pack 104 by electrical connections at the ends of the battery pack 104 (not shown) and within an external opening of the ballast housing 101 (not shown). To turn off the light, the user would simply need to disconnect the electrical connections between the battery pack 104 and the ballast 101.

To accomplish this default-on design, the ballast circuitry must have a closed circuit providing power to the ballast circuitry in the absence of the manual slide switch magnet. In a preferred embodiment, two circuits are used to accomplish the default-on design. A lower voltage subcircuit is used in addition to the main ballast circuit, the subcircuit being controlled by the external magnet and in turn controlling the main ballast circuit. In such a design, switching system OFF position means that the external magnet is pulling or pushing the reed switch contacts together, closing the subcircuit. The closed subcircuit then holds open the main ballast circuit, thus turning the searchlight off. When a user pushes the switching system to the ON position, the external magnet is moved out from the vicinity of the subcircuit reed switch contacts and the contacts move apart from each other, opening the subcircuit. The open subcircuit then ceases to hold open the main ballast circuit, so the main ballast circuit closes and thus turns the searchlight on. This design is default-on because in the complete absence of the external magnet, the low voltage subcircuit reed switch will open, therefore causing the main ballast circuit to close and the light to turn on.

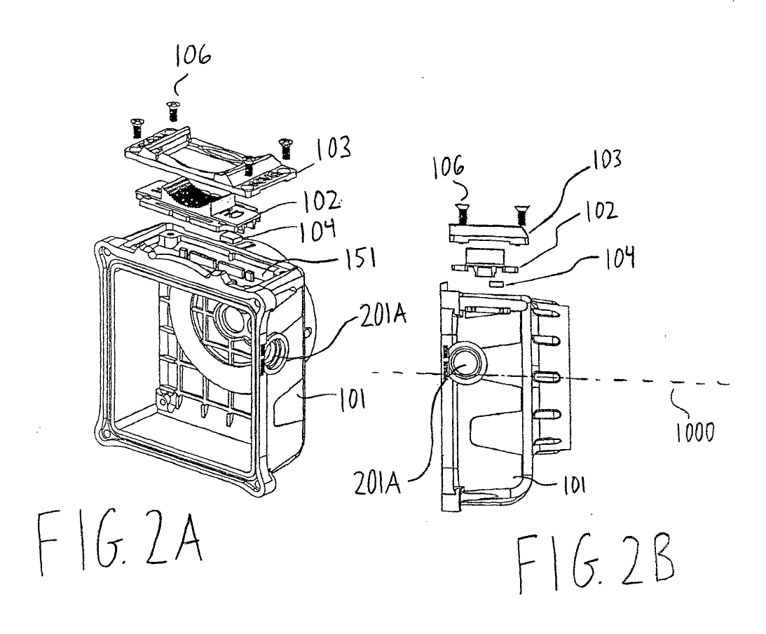

A fully assembly handheld searchlight illustrating the present invention is shown in FIGS. 1A and 1B. An exploded view of the reed switching system is also illustrated in FIGS. 2A and 2B. An example of the disclosed reed switching system is illustrated most clearly in FIG. 2. Ballast housing 101 is an enclosure designed to completely secure ballast components (including but not limited to wiring, circuit board, etc.) against exposure to water or debris. The ballast housing 101 may be injection-molded plastic, or another sturdy material that may be molded to the desired shape. As can been seen in the isometric view of FIG. 2A, ballast housing 101 is molded to include an open switch gap 151 under the manual slide switch 102 and between it and water-proof ballast housing 101. Switch gap 151 runs across most of the width of ballast housing 101 transverse to optical axis 1000, facilitating the cleaning and maintenance of slide switch 102 by, for example, placing it under running water so that debris can be flushed from beneath and around push/slide switch 102 and switch cover 103. Switch gap 151 may be open to the outside of ballast housing 101 via slits cut in the upper-most portion of ballast housing 101's vertical side walls. Such a design allows switch gap 151 to run all the way across the top of ballast housing 101, and allows a user to literally blow, via human lung power, the switching system clean of dust or debris.

Manual push/slide switch 102 may also be made of injection molded plastic or a similarly durable material, which may be polyacetal (chosen for its lubricity, spring strength, surface toughness, and durability) or another type of plastic. In its preferred embodiment, manual push/slide switch 102 is a piece of plastic with a ribbed top that accommodates manual pressure from a human finger or thumb while providing enough friction to avoid slippage. The plastic may be imprinted with the words “ON” and “OFF” thereon (the lettering either protruding from the surface or cut in relief into the surface). Manual push/slide switch 102 is designed so that it may be manually pushed by a user from one side of switch gap 151 to the other side of switch gap 151. To accomplish such movement, manual push/slide switch 102 may be molded with slots on its underside, the slots designed to slide along protruding ridges protruding from the surface of switch gap 151 (in other words, protruding from ballast housing 101). Manual push/slide switch 102 may be designed to be binary, meaning that it may be positioned in only two possible locations: in an ON position on one side of switch gap 151, or in an OFF position on the opposite side of switch gap 151.

Manual push/slide switch 102 is also designed to carry reed switch magnet 104 on its underside. Reed switch magnet 104 is the external magnet of the reed switch and fits into a slot molded into the plastic on the underside of manual push/slide switch 102. As the manual push/slide switch 102 is moved from its ON position across switch gap 151 to its OFF position, reed switch magnet 104 is simultaneously moved along switch gap 151. As discussed above, reed switch magnet 104 is used to open and close the ballast electrical circuit, in order to establish or cut off power to the ballast and thereby turn the light on and off. The reed switch magnet may be a cuboid-shaped magnet as illustrated in FIG. 2, or some other shape that works in this particular application. Reed switch magnet 104 needs to provide a strong enough magnetic field to be able to force the two blade type contacts (in the hermetically sealed glass tube embodiment) together with an electrical connection within the ballast housing 101. It is also preferable that the reed switch magnet 104 be small and light-weight enough to be easily moved by a user's manual operation of the manual push/slide switch 102.

Push/slide switch cover 103 is relatively thin with a rectangular hole in its middle, the hole allowing the ribbed button portion of manual push/slide switch 102 to protrude through push slide switch cover 103. Push/slide switch cover 103 is secured over the top of manual push/slide switch 102 while continuing to hold manual push/slide switch 102 loosely enough within switch gap 151 to remain operable. Push slide switch cover 103 is secured to ballast housing 101 with one or more screws or bolts 106. For example, as illustrated in FIG. 2A, push/slide switch cover 103 is secured with four screws 106, one in each corner, which screw directly into threaded holes in each corresponding corner of the top surface of ballast housing 101.

Push/slide switch cover 103 may also be formed of injection molded plastic, which may be polyacetal or another type of plastic. In a preferred embodiment, push/slide switch cover 103 may be made of a dissimilar material to the material used to make manual push/slide switch 102. Each component, or one of the two components, may be highly impregnated with Teflon (PTFE) and/or silicone. As manual push/slide switch 102 and push/slide switch cover 103 interact with each other during repeated switching, Teflon and/or silicon rises to the surface (at a molecular level) of the components and acts as an integral lubricant. Thus, if the push/slide switch cover 13 and the manual push/slide switch 102 are made from such different materials, the reed switching system requires no application of lubricants. As discussed above, application of lubricants to switching systems can cause dust, dirt, or debris to build up and form a gummy residue that may cause the switching system to bind, malfunction, snap, or break down.

As discussed, a powerful portable light may additionally, or may instead, be equipped with a pressure switching system. The pressure switching system comprises electrical wire leads, which connect to the relevant searchlight electrical circuit, and a pad or button which a user may depress in order to manipulate the switch. The electrical leads may be of any desirable length, allowing the pad or button to be placed anywhere desired, including near the trigger of a large fixed infantry weapon. For example, the portable light may be mounted on the barrel of such a weapon, out of reach of the weapon's operator when using the weapon, while the pressure switch pad or button is placed next to the weapon's trigger and within easy reach of the operator.

A unique aspect of the pressure switching system herein disclosed is that the electrical leads of the switch connect directly to the light's ballast circuit, the switching sub-circuit, instead of the light's battery pack, and allow the push/slide switch to be bypassed. Such a design allows a user to easily exchange battery modules without having to first disconnect the pressure switching system. Such a design also allows the pressure switching system to override the default-on nature of the reed switching system of the present invention, if both switching systems are used in combination with a light.

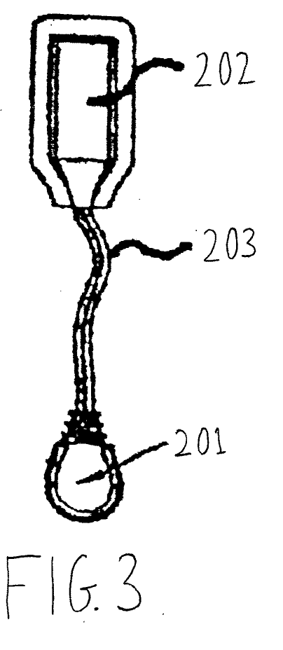

A pressure switching system utilized in combination with a reed switching system is illustrated in FIGS. 1 through 3. As can be seen most clearly in FIG. 3, a pressure switching system is comprised of three components: switch plug 201, switch pad 202 and switch lead 203. Pressure switch push pad 202 (which may alternatively be referred to as a pressure activation switch) is any pressure switch pad/button known in the art. Pressure switch pad 202 is utilized by applying manual pressure to its surface, which in turn causes two embedded contacts to compress together, thus completing the relevant electrical circuit and turning the device on.

The pressure switch pad 202 is not an ON/OFF button like the reed switching system described above, it is a “momentary switch.” The pressure switch pad is always ON while depressed by a user's manual pressure, and always OFF at all other times. A surface on the under-side of pressure switch pad 202 may be adhesive (adhesive in any manner known in the art, including adhesive tape and Velcro, for example) to enable pressure switch pad 202 to be temporarily (or permanently) attached in the desired location. For example, a user may position pressure switch pad 202 in close proximity to a weapon's forestock, or trigger, while the searchlight itself is mounted on the weapon's barrel or gas tube. Pressure switch lead 203 is a set of electrical wires running from plug 201 to pressure switch pad 202. Pressure switch lead 203 can be of any desirable length, and may be very long allowing pressure switching of a searchlight from some distance away.

Pressure switch plug 201 plugs into plug aperture 201A, seen in FIG. 2, on the side wall of sealed ballast housing 101. Pressure switch plug 201 operatively connects the pressure switching system directly to a searchlight's ballast circuitry. Ballast housing 101 should be water-proof despite the presence of pressure switch plug 201 and plug aperture 201A. To accomplish this, pressure switch plug 201 and plug aperture 201A may fit snuggly and pressure switch plug 201 may be equipped with a rubber or synthetic gasket or O-ring that seals the mating surfaces.

A user operates the pressure switching system herein disclosed by manually depressing pressure switch pad 202. While pressure switch pad 202 is depressed, the ballast circuit is closed, or completed, by the compressed contacts within pressure switch pad 202, and the searchlight produces light. As soon as a user ceases to apply pressure to pressure switch pad 202, the embedded contacts move apart and the ballast circuit is opened, or broken, ceasing light production. The pressure switching system allows a user to rapidly turn a searchlight on and off, an attribute which may be utilized, for example, to send light-beam signals.

As described, the disclosed reed switching system and pressure switching system may be used in combination in a portable light to produce a powerful and versatile lighting system. When the two systems are used in combination, the pressure switching system may be designed so that its operation overrides the reed switching system. When a searchlight is designed in this way, a user may be able to depress pressure switch pad 202 to activate the searchlight even while manual push/slide switch 102 is set to an OFF position.

A combination switching system is also advantageous because neither switching system used individually may be satisfactory. The reed switching system may produce a relatively loud “snapping” noise when a user moves manual push/slide switch from the ON position to the OFF position, or vice versa. Such a noise may be undesirable during a covert operation, so the silent pressure switching system may be preferable. On the other hand, surrounding atmospheric pressure may possibly be enough to depress pressure switch pad 202 in some situations—when the light is used underwater, for example—so the reed switching system may be preferable. It is therefore often advantageous to have both switching systems incorporated into one light. The preferred embodiment herein disclosed illustrates a searchlight design incorporating both the reed switching system and the pressure switching system.

While the present invention has been illustrated and described herein in terms of a preferred embodiment and several alternatives associated with a handheld HID lighting system for use in visible and covert operations, it is to be understood that the various components of the combination and the combination itself can have a multitude of additional uses and applications. For example, the reed and pressure switching systems herein disclosed can easily be adapted to other types of lighting systems, include searchlights, flashlights. The disclosed systems could be utilized in light-weight or commercial flashlights for use in homes by average consumers. The disclosed systems could be utilized in combination with other types of light generation, from incandescent bulbs to light emitting diodes (LEDs). The disclosed systems could also be utilized in lighting systems mounted to a variety of non-handheld vehicles or structures. Lighting systems incorporating the herein disclosed switching systems may be used in practically any conceivable operation, from heavy duty and covert to routine or mundane, including but not limited to commercial, scientific, law enforcement, security, and military-type operations. Accordingly, the invention should not be limited to just the particular descriptions and various drawing figures contained in this specification that merely illustrate one or more preferred embodiments and applications of the principles of the invention.

What is claimed is:

1. A switching system for a lighting system, comprising:
a manual switch having a magnet that is moved from a first position to a second position to turn the lighting system on and off, the switch being external to a sealed housing of the lighting system; and
a pair of contacts within the sealed housing that are operative to be moved into and out of contact with each other in response to movement of the magnet and that form part of a default-on circuit within the sealed housing that causes the lighting system to produce light in the absence of the magnet.

2. A pressure switching system for a lighting system, comprising:
a switch pad that responds to a minimum level of manual pressure applied by a user to turn the lighting system on and responds to an absence of the minimum level of manual pressure to turn or leave the lighting system off; and
a pair of leads connecting the switch pad directly to a ballast circuit of the lighting system.

3. A dual switching system for a lighting system, comprising:
a manual push/slide switch having a magnet that is moved from a first position to a second position to turn the lighting system on and off, the push/slide switch being external to a sealed ballast housing of the lighting system;
a pair of contacts within the sealed ballast housing that are operative to be moved into and out of contact with each other in response to movement of the magnet and that form part of a default-on circuit within the sealed ballast housing that causes the lighting system to product light in the absence of the magnet; and
a pressure switching system including switch pad that responds to a user's manual pressure to by-pass the manual push/slide switch and turn the lighting system on and in the absence of the user's manual pressure to turn or leave the lighting system off, and including a pair of leads connecting the switch pad directly to a ballast circuit within the sealed ballast housing.

4. The system as recited in claim 1, wherein the default-on circuit includes:
a main circuit that supplies power to a lamp assembly of the lighting system when in a closed position and separates the lamp assembly from power when in an open position; and
a subcircuit for controlling the main circuit, the subcircuit including the pair of contacts and being configured to hold the main circuit in the open position when the pair of contacts are closed and to hold the main circuit in the closed position when the pair of contacts are open.

5. The system as recited in claim 4, wherein the subcircuit is operative to be controlled by a user moving the manual switch from the first position to the second position.

6. The system as recited in claim 1, wherein an exterior surface of the sealed housing forms an open switch gap spanning a length of the exterior surface, and wherein the manual switch is positioned over the open switch gap and is operative to be moved between the first position and the second position along the length.

7. The system as recited in claim 6, wherein the exterior surface of the sealed housing further forms one or more slits that join the open switch gap and facilitate cleaning debris from the open switch gap.

8. The system as recited in claim 1, wherein the manual switch is formed of polyacetal.

9. The system as recited in claim 1, further comprising a switch cover secured to the sealed housing over the manual switch.

10. The system as recited in claim 9, wherein the switch cover is formed of polyacetal.

11. The system as recited in claim 9, wherein the manual switch and the switch cover are formed of dissimilar materials.

12. The system as recited in claim 9, wherein a material that forms the manual switch is impregnated with Teflon.

13. The system as recited in claim 9, wherein a material that forms the manual switch is impregnated with silicone.

14. The system as recited in claim 9, wherein a material that forms the switch cover is impregnated with Teflon.

15. The system as recited in claim 9, wherein a material that forms the switch cover is impregnated with silicone.

16. The system as recited in claim 9, wherein a repetitious act of the manual switch moving between the first position and the second position causes a plurality of molecular-level changes in a material forming the manual switch, the plurality of molecular-level changes creating an integral lubricant.

17. The system as recited in claim 9, wherein a repetitious act of the manual switch moving between the first position and the second position causes a plurality of molecular-level changes in a material forming the switch cover, the plurality of molecular-level changes creating an integral lubricant.

18. The system as recited in claim 2, wherein the switch pad includes an adhesive surface that facilitates adjustable placement of the switch pad by the user.

19. The system as recited in claim 18, wherein a lamp assembly of the lighting system is positioned along a barrel of a weapon including a trigger, and wherein the switch pad is positioned adjacent to the trigger.

20. The system as recited in claim 18, wherein the ballast circuit is sealed within a sealed ballast housing that includes a plug aperture, wherein the pair of leads includes a switch plug, and wherein the switch plug operatively connects the pair of leads to the ballast circuit through the plug aperture.

21. The system as recited in claim 20, wherein the sealed ballast housing is water-tight and the switch plug includes a gasket.

22. The system as recited in claim 20, wherein the sealed ballast housing is water-tight and the switch plug includes an O-ring.

23. The system as recited in claim 3, wherein the default-on circuit includes:
a main circuit that supplies electrical power to a lamp assembly of the lighting system when in a closed position and separates the lamp assembly from power when in an open position; and
a subcircuit for controlling the main circuit, the subcircuit including the pair of contacts and being configured to hold the main circuit in the open position when the pair of contacts are closed and to hold the main circuit in the closed position when the pair of contacts are open.

24. The system as recited in claim 23, wherein the subcircuit is operative to be controlled by a user moving the manual push/slide switch from the first position to the second position.

25. The system as recited in claim 3, wherein an exterior surface of the sealed ballast housing forms an open switch gap spanning a length of the exterior surface, and wherein the manual push/slide switch is positioned over the open switch gap and is operative to be moved between the first position and the second position along the length.

26. The system as recited in claim 25, wherein the exterior surface of the sealed ballast housing further forms one or more slits that join the open switch gap and facilitate cleaning debris from the open switch gap.

27. The system as recited in claim 3, wherein the manual push/slide switch is formed of polyacetal.

28. The system as recited in claim 3, further comprising a push/slide switch cover secured to the sealed ballast housing over the manual push/slide switch.

29. The system as recited in claim 28, wherein the push/slide switch cover is formed of polyacetal.

30. The system as recited in claim 28, wherein the manual push slide switch and the push/slide switch cover are formed of dissimilar materials.

31. The system as recited in claim 28, wherein a material that forms the manual push/slide switch is impregnated with Teflon.

32. The system as recited in claim 28, wherein a material that forms the manual push/slide switch is impregnated with silicone.

33. The system as recited in claim 28, wherein a material that forms the push/slide switch cover is impregnated with Teflon.

34. The system as recited in claim 28, wherein a material that forms the push/slide switch cover is impregnated with silicone.

35. The system as recited in claim 28, wherein a repetitious act of the manual push/slide switch moving between the first position and the second position causes a plurality of molecular-level changes in a material forming the manual push/slide switch, the plurality of molecular-level changes creating an integral lubricant.

36. The system as recited in claim 28, wherein a repetitious act of the manual push/slide switch moving between the first position and the second position causes a plurality of molecular-level changes in a material forming the push/slide switch cover, the plurality of molecular-level changes creating an integral lubricant.

37. The system as recited in claim 3, wherein the switch pad includes an adhesive surface that facilitates adjustable placement of the switch pad by the user.

38. The system as recited in claim 37, wherein a lamp assembly of the lighting system is positioned along a barrel of a weapon including a trigger, and wherein the switch pad is positioned adjacent to the trigger.

39. The system as recited in claim 3, wherein the ballast housing includes a plug aperture, wherein the pair of leads includes a switch plug, and wherein the switch plug operatively connects the pair of leads to the ballast circuit through the plug aperture.

40. The system as recited in claim 39, wherein the sealed ballast housing is water-tight and the switch plug includes a gasket.

41. The system as recited in claim 39, wherein the sealed ballast housing is water-tight and the switch plug includes an O-ring.

42. A push/slide switching system for a lighting system, comprising:
a manual push/slide switch having a magnet that is moved from a first position to a second position to turn the lighting system on and off, the push slide switch being external to a sealed ballast housing of the lighting system;
a main circuit that supplies power to a lamp assembly of the lighting system when in a first closed position and separates the lamp assembly from power when in a first open position; and
a subcircuit for controlling the main circuit, the subcircuit being configured to hold the main circuit in the first open position when the subcircuit is in a second closed position and to hold the main circuit in the first closed position when the subcircuit is in a second open position.

43. A push/slide switching system for a lighting system, comprising:
a manual push/slide switch having a magnet that is moved from a first position to a second position to turn the lighting system on and off, the push/slide switch being external to a sealed ballast housing of the lighting system;
a ballast circuit including a main circuit that supplies power to a lamp assembly of the lighting system when in a first closed position and separates the lamp assembly from power when in a first open position, and including a subcircuit for controlling the main circuit, the subcircuit being configured to hold the main circuit in the first open position when the subcircuit is in a second closed position and to hold the main circuit in the first closed position when the subcircuit is in a second open position; and
a pressure switching system including a switch pad that responds to a user's manual pressure to turn the lighting system on and in the absence of the user's manual pressure to leave the lighting system off, and including a pair of leads connecting the switch pad directly to the ballast circuit.

44. The system as recited in claim 43, wherein the pair of leads operatively connect the switch pad to the main circuit, and wherein the pressure switching system controls the main circuit.

45. The system as recited in claim 43, wherein the pair of leads operatively connect the switch pad to the subcircuit, and wherein the pressure switching system controls the subcircuit.
